(19) United States
(12) Patent Application Publication
(10) Pub. No.: US 2025/0043431 A1
(43) Pub. Date: Feb. 6, 2025

(54) HYBRID CHEMICAL-PHYSICAL VAPOR DEPOSITION PROCESS FOR THE SYNTHESIS OF ENVIRONMENTAL BARRIER COATINGS

(71) Applicant: Oerlikon Surface Solutions AG, Pfäffikon, Pfaffikon (CH)

(72) Inventors: DIANYING CHEN, WESTBURY, NY (US); BENO WIDRIG, BAD RAGAZ (CH); JUERGEN RAMM, MAIENFELD (CH)

(21) Appl. No.: 18/714,826

(22) PCT Filed: Nov. 30, 2022
(86) PCT No.: PCT/EP2022/000107

§ 371 Date: May 30, 2024

Related U.S. Application Data
(60) Provisional application No. 63/284,243, filed on Nov. 30, 2021.

(51) Int. Cl. C23C 28/04; C04B 35/80; C04B 41/45; C04B 41/50; C04B 41/52; C04B 41/87; C04B 41/89

(52) U.S. Cl. CPC C23C 28/042; C04B 35/80; C04B 41/4515; C04B 41/4533; C04B 41/4558; C04B 41/5024; C04B 41/5035; C04B 41/522; C04B 41/87; C04B 41/89

(57) ABSTRACT

A manufacturing process for the synthesis of environmental barrier coating system (EBC) which protect Si-based Ceramic Matrix Composite (CMC) material against oxidation and volatilization at high temperatures is disclosed. The manufacturing process is carried out in vacuum and includes steps of depositing a silicon bond coat and an oxygen containing barrier coating. The process is supported by plasma, preferably through and arc discharge, which lead to full dissociation of the gas precursors such as silane. Plasma is as well used for pre-treatment of substrates in an uninterrupted process chain. A deposition system with essential vacuum and plasma components is disclosed as well as EBC coatings manufactured by the process.

### SCOPE OF THE INVENTION

The invention relates to a deposition technology and a deposition process for the synthesis of environmental barrier coatings (EBC) which protect Si-based Ceramic Matrix Composite (CMC) material against oxidation and volatilization at high temperatures.

### BACKGROUND

Due to their high specific strength and their high temperatures stability, silicon carbide (SiC) and silicon nitride based ceramic matrix composite (CMC) materials (both summarized here under “Si-based CMC materials”) are materials of choice for the hot section in next generation gas turbine engines. However, CMCs experience rapid recession in water vapor environment resulting in the reduction of the mechanical strength and structural integrity of CMCs components. Thus, Si-based CMCs need to be protected by ceramic environmental barrier coatings (EBCs) to prevent the surface recession of these CMC materials. The approach for the coating design is based on a combination of bond coat (adhesion layer) and a chemical barrier dedicated for the specific Si-based material. For SiC-based materials, some combinations consisting of bond coat and barrier layer have been investigated in the past. Promising EBC systems consist of silicon bond coat applied to the substrate followed by rare-earth silicate protective coating layers. Among rare-earth silicates, Yb₂Si₂O₇ appears to be the most promising candidate because of its low recession rate in water vapor containing environment, excellent phase stability up to its melting temperature of 1850° C., and reasonably well-matched coefficient of thermal expansion (CTE) with silicon based CMCs substrates.

There are different approaches to deposit such coatings onto SiC-based components utilized in the hot section of the gas turbine.

Air plasma spray process (APS) has been widely used for the dense EBCs deposition. The advantages of this technology are low cost, high deposition rate and wide composition flexibility. However, when coating the complex shaped engine parts such as blades and vanes, APS process is challenging due to the spray distance and spray angle variation which will cause non-uniform coating microstructure and thickness. In addition, the control of interfaces in APS multi-layer coatings and specific nucleation processes might be difficult due to the deposition at atmospheric conditions. Therefore, novel process approaches are needed for EBCs deposition for different engine components application which allows better control on coating microstructure and properties.

In US 2020/0039892 A1, a chemical vapor deposition (CVD) is described for the deposition of the silicon bond coat as a part of the EBC coating. This process is realized at deposition pressures in the range from about 115 torr to about 150 torr, which correspond to the range from ca 15 300 Pa to ca 20 000 Pa, and utilizes silicon-containing precursors. However, in order to dissociate the precursor and get a crystalline Si coating deposition, the required deposition temperature is above 900° C. with a preference of substrate temperatures of about 1100° C. The high deposition temperature may cause the oxidation of the SiC/SiC CMC substrate and deteriorate its mechanical properties.

### OBJECTIVE OF THE INVENTION

In this invention, a hybrid chemical/physical vapor process was developed for the deposition of EBC coatings. A typical EBC coating consists of a layer stack shown in FIG. 1. The hybrid CVD/PVD process allows the deposition of the complete EBC layer stack at relatively low deposition temperature without interruption of vacuum. The coating is composed of a Si bond coat and a Yb—Si—O top coat, and may comprise additional coatings.

The FIG. 1 shows:
1 Si-based CMC substrate
2 Interface to silicon bond coat (optional)
3a, 3b Silicon bond coat which may have modifications with respect to morphology (e.g. grain size) or composition (e.g. incorporation of doping) within the bond coat
4 Transition layer to barrier coating (e.g. silicate) which may different in composition and structure from bond coat and/or barrier coating
5 Barrier coating, here as an example Yb—Si—O
6 Top coat to improve properties of barrier coating, i.e. with respect to erosion resistance, water vapor stability, CMAS resistance, etc. (optional)

### DESCRIPTION OF THE INVENTION

In the following, the invention is described with reference to FIG. 1 and for a specific layer stack. The description is meant as an example only and should not be understood to limit the broader scope of the invention.

The current invention uses the combination of plasma activated chemical vapor deposition (CVD) and physical vapor deposition (PVD) processes for the EBC deposition. The activation of vapor in plasma is a method which enables coating deposition at much lower temperature than in conventional CVD. This is significantly different from the conventional chemical vapor deposition such as the one used in patent application US 2020/0039892 A1.

For a better understanding between the state-of-the-art technology and the process of invention, the sequence of the process steps is explained with reference to FIG. 2 for the deposition of the silicon bond coat and with reference to FIG. 5 for the complete EBC, respectively. In FIG. 10, the schematics of a deposition system is given which allows the deposition of EBC with the inventive process.

A Silicon bond coat, in the context of EBC layer systems, is a Si layer which exhibits excellent chemical and bonding compatibility with the CMC surface. Furthermore, the silicon bond coating should have a coefficient of thermal expansion (CTE) close to that of the CMC substrate. The silicon bond coat is typically a homogeneous layer, which may comprise alloying elements in addition to Si.

The deposition of the silicon bond coat is explained now with reference to FIG. 2. The process 100 comprises the steps of substrate loading 101, pump down the deposition chamber 102, heating substrates to required temperature 103, pre-treatment of the substrates by plasma 104, initiating gas arc discharge and silicon precursor 105, optional doping form gas source or solid state source 106, deposition of silicon bond coat 107, cool down system 108, and venting and de-loading substrates 109. The steps 103 through 107 are process steps that utilize plasma 110.

The pre-treatment step 104 is introduced used to clean the substrates and remove native oxide on the substrate. Plasma plays an essential role for the pre-treatment of the Si-based substrates, in addition to that plasma helps to reduce the deposition temperature. The native oxide at the surface of the Si-based substrates may prevent a good adhesion of the subsequent silicon bond coat and needs therefore to be removed. The removal of the native oxide is done by plasma activation of reactive gases utilized to reduce the oxide and form volatile compounds with oxygen which are pumped away. The creation of atomic or ionized hydrogen from a hydrogen discharge is one example for such a reactive surface pre-treatment or cleaning. Here, an argon/hydrogen discharge was used with a discharge current of 200 A, discharge voltage of 50 V, an argon flow of 60 sccm (standard cubic centimeters per minute) and a hydrogen flow of 300 sccm. Also loose carbon contaminations are volatilized in such a process. Typical thickness of these oxides or carbon contaminations are in the order of 10 nm.

An exposure of as cleaned substrate surfaces to ambient would result in an immediate recontamination of the as treated substrate surface because such a pre-treated surface is high susceptible to reactions with gases in ambient atmosphere, as it is known by persons skilled in vacuum deposition technology. Therefore, there must be the direct transition without vacuum break to the next process step for the deposition of the EBC, the silicon bond coat. All this, surface pre-treatment, cleaning and controlled vacuum environment ensure a better control for the nucleation processes of the silicon bond coat on the Si-based substrate and therefore a better formation of the interface.

The formation of the interface is illustrated in FIG. 3 which shows a silicon bond coat synthesized utilizing the inventive process. FIG. 3 shows a silicon bond coat with a thickness of 3 μm deposited from a silane precursor (SiH₄). The dissociation and activation of the silane was achieved by an arc discharge in argon working gas with an Ar flow of 80 sccm and an arc discharge current of 120 A and an arc voltage of 75 V. A silane flow of 250 sccm was utilized. The substrate temperature during deposition was 550° C. FIG. 3 shows the cross section of the silicon coating at a silicon carbide substrate obtained by transmission electron microscopy (TEM). The interface consists of a nucleation zone of a thickness of about 200 nm and after this nucleation zone a transition to columnar growth is visible demonstrating the possibility of the inventive process to achieve columnar growth of silicon at already low temperatures. The Si coating (FIG. 3) has a segmented strain tolerant microstructure.

In the context of the present innovation, vacuum is understood as pressure less than 1×10³ Pa but not lower than 1×10⁻⁶ Pa. The pressure range between 100 Pa and 0.001 Pa is most preferred. Pressure above 1×10³ Pa increases risk for contamination, while pressure below 1×10⁻⁶ Pa cross over to the ultra-high vacuum range where special material and equipment, such as vacuum pumps is required.

The cross section micrograph obtained by TEM of the silicon bond coat deposited on SiC substrate demonstrates that columnar growth can be achieved and that the inventive plasma processing is an appropriate technique to control the nucleation and growth of the silicon bond coat at low temperature.

The excellent adhesion of the silicon bond coat to the substrate is characterized by the formation of dislocations in the substrate surface. This is illustrated in FIG. 4. The Bright Field (BF) TEM cross section shows an interface between the SiC substrate and a thin silicon bond coat. The micrograph gives an impression of the good quality of interface between the SiC and the silicon bond coat. The interface is sharp and there is no porosity visible. The dislocation created in the SiC substrate by the silicon bond coat after annealing proof the excellent adhesion and stability of this SiC—Si interface. Referring to the comments above, this interface was formed in a vacuum process sequence consisting of a plasma treatment of the SiC surface at about 550° C. substrate temperature and the deposition of the silicon bond coat again in plasma environment, without interruption of the vacuum.

Another feature of the inventive process is the utilization of an arc discharge for the dissociation of the gas precursor, in this example silane. The high electron current density of the arc discharge, typical parameter of such a discharge are 20 A to 1000 A at voltages between 15 V and 100 V, result in a complete dissociation of the precursor. This means that approximately 100% of the Si fed into the system with the precursor will undergo reaction in the chamber. This is different from other types of plasma enhanced CVD processes in which some amount of unreacted Si-containing (silicon containing) precursors are pumped away. The complete dissociation also produces silicon coatings which are free from hydrogen or show only very little hydrogen content in the as deposited silicon bond coat. This contributes strongly to the stability of the silicon bond coat at high temperatures, because hydrogen contribute to destabilization. The hydrogen content in the silicon bond coat was measured by Elastic Recoil Detection and is below 5 at. %, usually even below 3 at. %. Important is that these characteristics of the inventive process are realized at moderate and low substrate temperatures below 600° C.

The deposition of the Si bond coat is realized by plasma activation and dissociation of silicon containing precursors. A variety silicon containing gases can be used as Si-containing precursor and may comprise one or more of the following chemicals: Silane, Disilane, Dichlorosilane, Trichlorosilane, Silicon Tetrachloride, Methylsilane, Silicon Tetrafluoride, Trimethysilane, Tetramethylsilane, Hexachlorodisilane etc. The typical flow rate for the Silicon containing precursor gas ranges from 1 sccm to 10 l/m, preferably between 10 sccm to 1 l/m. In the following experiments, silane is used as a precursor. For the activation of the precursor, an arc discharge is utilized. This arc discharge is characterized by electron currents between 10 A and 400 A and discharge voltages between 15 V and 100 V. The arc discharge can be created by the discharge in a noble gas, like argon, or by cathodic arc evaporation of a metallic target. The high electron current of the arc discharge is very efficient for the dissociation of the silicon containing precursor. This is the precondition to synthesize silicon coatings with high deposition rates at substrate temperatures below 600° C. The degree of utilization of the silicon in the precursor is determined as the ratio of silicon atoms deposited in the chamber and the silicon atoms fed to the chamber by the precursor. The degree of utilization according to the inventive process is above 80%, preferably above 90%. Due to the very efficient dissociation of the silicon containing precursor enhanced by the argon plasma gas, the coating deposition rate shows nearly no dependency from substrate temperature in the range between 300° C. and 600° C. This is an advantage over conventional thermal CVD technology in which the substrate temperature has dominant influence on deposition rate.

Another advantage of the inventive process is the possibility to combine the plasma activated deposition with additional doping sources. As an example, for doping of the silicon bond with another element, the process technology allows to run the silicon containing precursor with an additional gaseous precursor, for example a carbon- or boron-containing precursor or combination of these. Additionally the inventive process allows also the simultaneous evaporation from silicon containing precursor in combination with a solid state source. The solid state source can particularly be the volatilization of a metal or semimetal by cathodic arc evaporation or sputtering. As an example, utilizing the process parameter mentioned above for the silicon bond coat deposition, an additional sputter source with an aluminum target can be initiated resulting in doping of the silicon bond coat by aluminum. Also other targets for sputtering or cathodic arc evaporation can be utilized for doping the silicon bond coat with suitable elements. Chemicals comprising of one or more of the following elements can be incorporated in the silicon bond coat: Al, B, C, O, N, Ga, In, P, Li, Na, K, Ca, Mg, Sr, Ba.

In FIG. 2, all the plasma enhanced process steps are framed with a dashed line. It can be seen that all the plasma based steps are performed without interruption of the vacuum, i.e. throughout the process chain from substrate loading until venting the deposition system after completing the silicon bond coat deposition. The uninterrupted vacuum process has the advantage of reduced contamination compared to processes where the vacuum is interrupted.

In addition to substrate pre-treatment and deposition of silicon bond coat, the inventive process includes also the synthesis of complete EBC layer stacks. In the inventive process, also this complete process sequence is realized in one process, i.e. without vacuum interruption. This is illustrated in the process sequence shown in FIG. 5. The deposition of the complete EBC coating system includes substrate pre-treatment and silicon bond coat deposition and the deposition of the barrier top coating. In its simplest form, the deposition of the barrier top coating is performed directly after the deposition of the silicon bond coat. However, if there is additional adaptation between silicon bond coat and barrier coating necessary, e.g. for the purpose of enhancing the water vapor/oxygen diffusion barrier, additional layers can be incorporated. The process sequence 200 typically comprise the steps of loading SiC-CMC substrate 201, pump down deposition chamber 202, heating substrates to moderate temperature 203, pre-treatment substrates by plasma 204, initiating gas arc discharge and silicon precursor 205, deposition silicon bond coat 206, initiating cathodic arc discharge of Me target 207, initiating silicon precursor (optional) and oxygen 208, deposition Me-Si—O barrier coating 209, cool down system 210, and venting and de-loading SiC-CMC with EBC 211. In FIG. 5, all the plasma-based process steps 203 through 209 are framed with a dashed line 212. It can be seen that all the plasma based steps are performed without interruption of the vacuum. The vacuum is thus not broken from the step of substrate loading until venting the deposition system after completion of the whole EBC layer stack.

In an EBC coating system, the barrier coating serves as a chemical barrier between the silicon bond coating and a barrier coating or a top layer. The barrier coating should avoid potential chemical reactions that would damage the EBC. The barrier coating should protect the bond coating from oxidation and should ideally be resistant against water vapor attacks.

FIG. 6 shows a first example for a complete EBC layer stack according to the inventive process consisting of SiC substrate, silicon bond coat and Al—Si—O barrier coating. In this example, the silicon bond coat with a thickness of 29 μm was deposited on the pre-treated SiC substrate with the utilization of the silane source. The silane was activated and dissociated in the arc discharge for silicon bond coat synthesis. The arc discharge current was 120 A, the discharge voltage was 75 V, the argon gas flow was 80 sccm and the silane flow was 250 sccm. Following the deposition of the silicon bond coat, cathodic arc evaporation utilizing an aluminum target as cathode was initiated utilizing an arc current of 145 A, oxygen with a flow of 220 sccm and silane with a flow of 66 was added to this discharge. The deposition temperature was 550° C. With these parameters, 30 μm Al—Si—O were deposited with the atomic composition of Al₃₅Si₅O₆₀. In this deposition, the content of the Al in the coating was controlled by the evaporation rate from the Al target and the Si content of the coating by the flow of the silane precursor. Oxygen flow was adjusted to achieve a complete oxidation of the Al—Si—O. The FIG. 6 shows the coating after annealing at 1400° C. The interfaces are sharp and there is no porosity formed between—neither between the silicon bond coat and the SiC nor between the silicon bond coat and the Al—Si—O barrier coating.

Another example of a coating system produced by the inventive process is given in FIG. 7. The figure shows an EBC layer stack consisting of silicon bond coat and dense Yb—Si—O barrier coating deposited on a SiC substrate. The Figure shows the TEM cross section of the layer stack as deposited. The interfaces are sharp and without porosity indicating good coating adhesion. A few droplets, probably defects during silicon bond coat deposition and droplets from cathodic arc evaporation, are visible in this cross section. These droplets and defects are assumed to be not critical for the functionality of the coating system and usually disappear during annealing (will be demonstrated in FIG. 8). The substrate surface was pre-treated by reactive plasma and a thin silicon bond coat of 3 μm was deposited in an argon arc discharge with 120 A discharge current and 75 V discharge voltage utilizing 80 sccm argon flow and a flow of 250 sccm silane. After deposition of the silicon bond coat, ytterbium was evaporated from an elemental ytterbium target which was used as cathode in cathodic arc evaporation. An arc current of 120 A was utilized to evaporate the ytterbium (Yb) target and a silane flow of 200 sccm and an oxygen flow of 400 sccm was utilized to synthesize the Yb—Si—O barrier coating. The deposition temperature was 550° C. As result, a Yb₂₉Si₁₁O₅₉ barrier coating (measured by EDX) was synthesized. The complete process sequence was realized without break of vacuum, i.e. in one consecutive process sequence.

FIG. 8 shows the layer stack after of FIG. 7 after annealing at 1400° C. Still the interfaces are stable and flat and there is no porosity formed. In the silicon bond coat, a columnar structure is visible and on top of the silicon bond coat a thin (about 300 nm) and dense silicon oxide is formed. Between the silicon oxide and the Yb—Si—O barrier coating a thin (about 200 nm) transition can be recognized.

Another example for the current invention is shown in FIG. 9, a complete EBC layer stack was deposited at a SiC substrate with a silicon bond coat of ˜30 μm and an Yb—Si—O barrier coating of ˜12 μm. The Yb—Si—O coating contains ˜77 vol % Yb₂Si₂O₇ and ˜23 vol % Yb₂SiO₅ phases. This demonstrated the flexibility of the invented process for the deposition of EBCs with various chemistries. The combination of the Yb₂Si₂O₇ and Yb₂SiO₅ phases is advantageous to obtain a barrier coating with low corrosion rate and a coefficient of thermal expansion well-matched with CMC substrates. The Yb₂SiO₅ phase has particularly low recession rate in water vapor containing environment (sometimes termed corrosion rate), but a thermal expansion coefficient which does not match well with SiC/SiC CMC substrates. The phase Yb₂Si₂O₇ on the other hand, has a coefficient of thermal expansion which well matched with SiC/SiC CMC substrates but a recession rate which is higher than the Yb₂SiO₅ phase. The synthesis of a barrier coating which comprise both Yb₂Si₂O₇ and Yb₂SiO₅ phases allow a technically efficient combination these two properties.

In one further aspect of the invention, the coating method can be used to produce barrier coatings which comprise one or more Yb—Si—O phases combined with at least one second type of phase that does not contain Yb. The combination of Yb—Si—O with second type of phases allows the tailoring of the coefficient of thermal expansion for different substrates and coating layers. The second type of phase may be Al₂O₃, an alkali metal oxide or an alkaline earth metal oxide. In particular, Yb₂Si₂O₇ or Yb₂SiO₅ can be combined with Al₂O₃, an alkali metal oxide or an alkaline earth metal oxide. The presented EBC layer stacks demonstrate the ability of the invented process for the fabrication of such a structure in one process sequence. FIG. 10 gives a schematic of a deposition system utilized for such a process sequence.

The FIG. 10 illustrates the combination of gas sources for working gases like argon and gas sources for reactive gases like oxygen, nitrogen, hydrocarbon and gas sources for the Si-containing precursor. These sources can be operated alone or in combination with solid state sources like cathodic arc sources and sputter sources. A very important feature of the processes is the plasma utilization. This includes the surface pre-treatment which defines the reliable conditions for the silicon bond coat deposition which helps to create the strain tolerant columnar structure. In the synthesis of the silicon bond coat, the nearly complete dissociation of the silicon containing precursors in the arc discharge is important. It helps to avoid hydrogen incorporation in the silicon bond coat at the low deposition temperatures below 600° C. The optional incorporation of dopants during silicon growth and the simplicity to add additional gas sources or solid state sources in this deposition step contributes to the versability of the inventive process. The plasma enhancement by an arc discharge is the key to control the deposition rates of the silicon containing precursor independently for deposition temperatures between 300° C. and 600° C.

### DESCRIPTION OF FIGURES

FIG. 1: Schematic illustration of a layer stack deposited by the inventive process. The whole layer stack (bond coat and barrier coating and all additional interface coatings) is deposited without interruption of the process vacuum, i.e. in one process sequence and in plasma environment.

FIG. 2: Sequence of the process steps the deposition of the silicon bond coat according to the inventive process

FIG. 3: TEM cross section micrograph from silicon bond coat with columnar morphology showing columnar widths between 10 nm and 50 nm.

FIG. 4: BF-TEM cross sections of a SiC-silicon bond coat interface after annealing at 1400° C. with the formation of dislocations in the SiC substrate.

FIG. 5: Example for the process sequence for the deposition of the complete EBC layer stack consisting of SiC pre-treatment/silicon bond coat/barrier coating

FIG. 6: Scanning electron microscopy (SEM) cross section micrograph of a SiC-silicon bond coat—Al₃₅Si₅O₆₀ layer stack annealed at 1400° C.

FIG. 7: TEM cross section of the SiC substrate with silicon bond coat (3 μm) and Yb—Si—O barrier coating (6 μm).

FIG. 8: TEM cross section of the SiC substrate with silicon bond coat (3 μm) and Yb—Si—O barrier coating (6 μm) after annealing at 1400° C.

FIG. 9: SEM image of as-deposited Yb—Si—O/Si EBC using the hybrid vapor deposition process FIG. 10: Schematics of the deposition system of the PVD/CVD hybrid process including the process sequence of substrate pre-treatment, deposition of silicon bond coat and barrier coating.

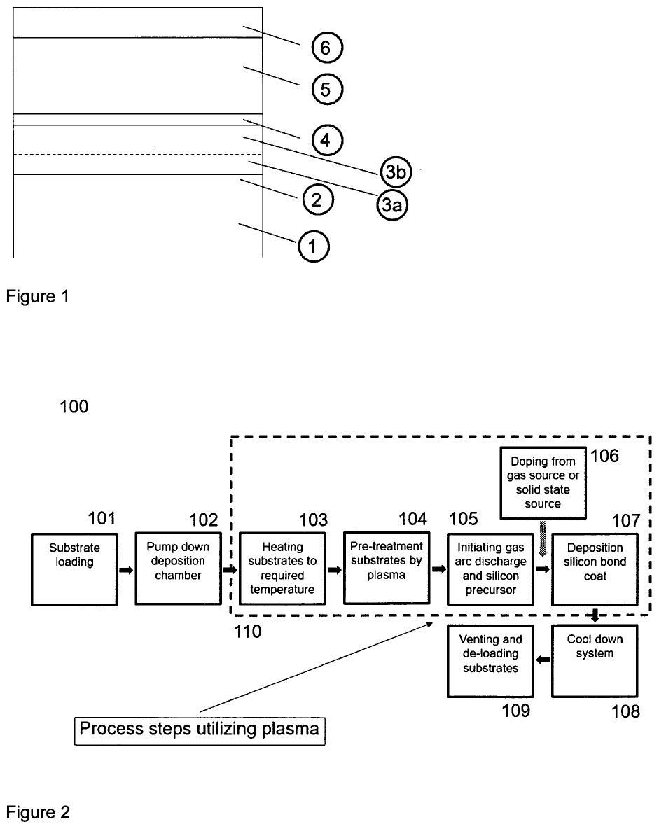

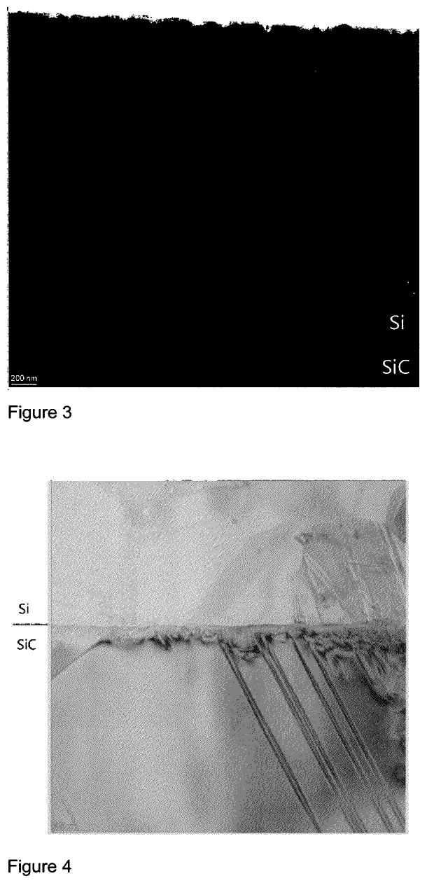

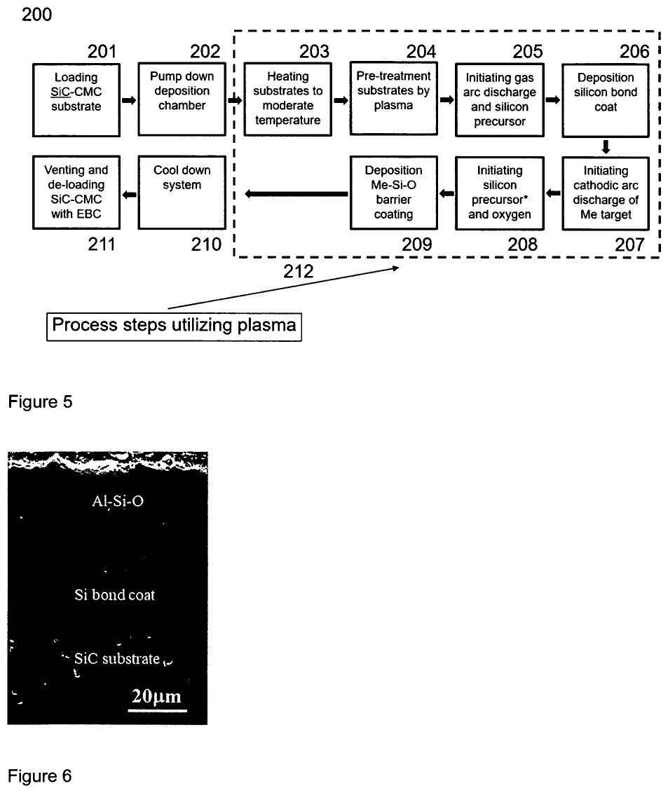

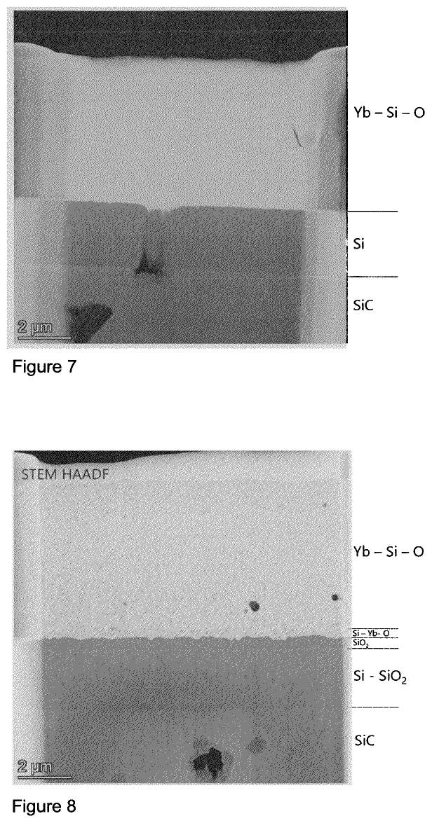

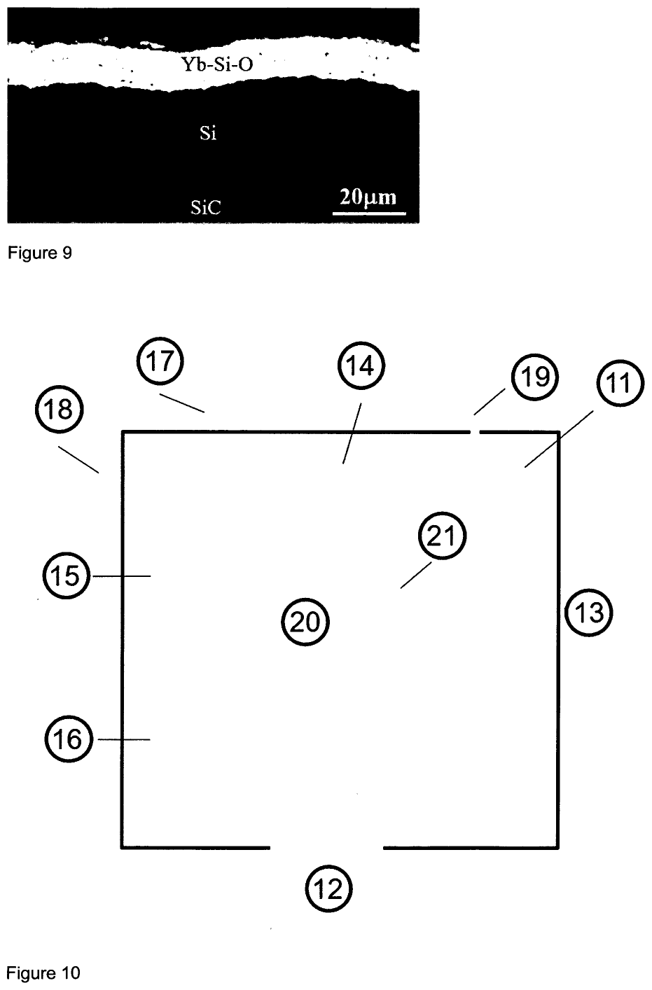

### LIST OF REFERENCE SIGNS

1 substrate
2 Interface to bond coat (optional)
3a bond coat
3b bond coat which may have modifications with respect to morphology (e.g. grain size) or composition (e.g. incorporation of doping elements)
4 transition layer to barrier coating (e.g. silicate) which may different in composition and structure from bond coat and/or barrier coating
5 barrier coating
6 optional top coat to improve properties of barrier coating, e.g. with respect to erosion resistance, water vapor stability, CMAS resistance, etc.
11 vacuum deposition chamber
12 pumping system
13 door to load substrates
14 gas arc discharge source (multiple)
15 cathodic arc source (multiple)
16 sputter source (multiple)
17 working gas inlet for the operation of the gas arc discharge (multiple)
18 gas inlet for the reactive gases (multiple)
19 gas inlet for Si-containing precursor
20 substrate holder with substrate bias
21 substrate heater
100 Process sequence for the deposition of silicon bond coat
101 Substrate loading
102 Pump down deposition chamber
103 Heating substrates to required temperature
104 Pre-treatment substrates by plasma
105 Initiating gas arc discharge and silicon precursor
106 Doping from gas source or solid state source (optional)
107 Deposition silicon bond coat
108 Cool down system
109 Venting and de-loading substrates
110 Process steps utilizing plasma
200 Process sequence for the deposition of the complete EBC layer stack
201 Loading SiC-CMC substrate
202 Pump down deposition chamber
203 Heating substrates to moderate temperature
204 Pre-treatment substrates by plasma
205 Initiating gas arc discharge and silicon precursor
206 Deposition silicon bond coat
207 Initiating cathodic arc discharge of Me target
208 Initiating silicon precursor (optional) and oxygen
209 Deposition Me-Si—O barrier coating
210 Cool down system
211 Venting and de-loading SiC-CMC with EBC
212 Process steps utilizing plasma

What is claimed is:

1. A manufacturing process for manufacturing an environmental barrier coating (EBC) system onto a substrate, comprising a step of depositing a silicon bond coat, and at least one step of depositing an oxygen-containing barrier coating,
wherein the manufacturing process is performed in vacuum environment.

2. The manufacturing process according to claim 1, wherein the manufacturing process comprises at least one substrate pre-treatment step performed in vacuum environment prior to the step of depositing a silicon bond coat.

3. The manufacturing process according to claim 2, wherein the at least one substrate pre-treatment step and the step of deposition of a silicon bond coat, and the at least one step of depositing an oxygen-containing barrier coating are part of a vacuum process without interruption of the vacuum during or between said process steps.

4. The manufacturing process according to claim 1, wherein the vacuum environment comprises plasma.

5. The manufacturing process according to claim 4, wherein the plasma environment is generated by at least one arc discharge, preferably in at least one noble gas, most preferably in argon.

6. The manufacturing process according to claim 5, wherein the at least one arc discharges is operated at a discharge currents in the range from 20 A to 1000 A, and a discharge voltages in the range from 15 V to 100 V.

7. The manufacturing process according to claim 5, wherein the at least one arc discharge is utilized to dissociate at least one silicon containing precursor.

8. The manufacturing process according to claim 1, wherein the process is performed at temperatures of the substrate lower than 600° C.

9. The manufacturing process according to claim 1, wherein the silicon bond coat is deposited to a thickness in the range between 0.01 μm and 500 μm.

10. The manufacturing process according to claim 9, wherein the silicon bond coat is oxidized after deposition.

11. The manufacturing process according to claim 9, wherein the silicon bond coat is doped by sputtering at least one doping element from at least one sputtering source.

12. The manufacturing process according to claim 11, wherein the at least one doping element is one or more elements selected from Al, B, C, O, N, Ga, In, P, Li, Na, K, Ca, Mg, Sr and Ba.

13. The manufacturing process according to claim 1, wherein the oxygen-containing barrier coating is produced by cathodic arc evaporation of at least one metallic target, the metallic target comprising Al or comprising at least one rare earth element.

14. The manufacturing process according to claim 13, wherein the arc evaporation is performed in oxygen containing environment.

15. The manufacturing process according to claim 13, wherein at least one silicon containing precursor is introduced simultaneously to cathodic arc evaporation of the at least one metallic target.

16. The manufacturing process according to claim 15, wherein the silicon precursor is introduced in a flow range from 1 sccm to 10 l/m, preferably in a flow range between 10 sccm to 1 l/m.

17. The manufacturing process according to claim 13, wherein the oxygen containing barrier coating comprises the phases Yb₂Si₂O₇ and Yb₂SiO₅.

18. The manufacturing process according to claim 13, wherein the oxygen containing barrier coating comprises at least one Yb—Si—O phase and at least one second type of phase, the second type of phase being at least one of Al₂O₃, an alkali metal oxide or an alkaline earth metal oxide.

19. The manufacturing process according to claim 2, wherein the pretreatment reduces the thickness of surface oxides, particularly silicon oxides in the case of Si-based substrates, to thickness below 30 nm, preferably below 10 nm.

20. The manufacturing process according to claim 1, wherein the substrate consist of or comprise ceramic matrix composite material (CMC).

21. A deposition system for manufacturing environmental barrier coatings with the process according to claim 1, wherein the deposition system comprises at least one vacuum deposition chamber, at least one pumping system, and at least one plasma source.

22. An environmental barrier coating system manufactured according to claim 1, deposited on a substrate, wherein the interface between the substrate and the silicon bond coat is sharp and without porosity.
